(19) United States
(12) Patent Application Publication
(10) Pub. No.: US 2012/0005819 A1
(43) Pub. Date: Jan. 12, 2012

(54) Whirlpool Jet Nozzle Assembly and Jet Apparatus

(75) Inventors: Drew J. Yuhas, Pennington, NJ (US); Michael J. Webster, Center Township, OH (US)

(73) Assignee: AS IP Holdco, L.L.C., Piscataway, NJ (US)

(21) Appl. No.: 12/833,783

(22) Filed: Jul. 9, 2010

(51) Int. Cl. E03C 1/084; B23P 17/04

(52) U.S. Cl. 4/541.6; 29/428

(57) ABSTRACT

A jet nozzle assembly is included which may be used in a jet apparatus having a jet housing and a jet head. The jet nozzle assembly includes a jet nozzle portion having a first end, a second end and a jet nozzle body extending from the first end to the second end of the jet nozzle portion, wherein the jet nozzle body is configured to provide an aerated flow of fluid for exiting the second end of the jet nozzle body and the jet nozzle body defines a passage therethough extending from the first end to the second end of the jet nozzle portion, and wherein the jet nozzle body has at least one opening for receiving fluid and/or air into the passage and has at least one fastening mechanism for attaching the nozzle body to a jet apparatus. The jet nozzle assembly also includes a jet nozzle cover having an exterior surface and an interior surface, and having at least one opening extending through the jet nozzle cover from the interior surface to the exterior surface for allowing passage of fluid, wherein the jet nozzle cover and the jet nozzle portion form a unitary structure.

### BACKGROUND OF THE INVENTION

1. Field of the Invention

The invention involves the field of whirlpool jets for baths, hot tubs, spas and the like.

2. Description of Related Art

Jets are used to introduce water under pressure and/or aerated in a variety of structures including in bath tubs, hot tubs, spas, physical therapy tubs, and the like. Typically, such jets are located at or near the bottom of the water holding structure such as the tub basin. Such jets are commonly designed to be rotatable so that the user can position the jet in different directions. To accommodate the maneuverability, such jets typically use a round or spherical inner directional piece for aiming the jet. Also known are jets that have a rotary body that rotates about an axis for providing a pattern of water that swirls about the axis. In use, most such jets operate by withdrawing water from the tub/basin through suction, and pumping it through a water recirculation unit for discharging into the tub/basin water again through the jet nozzles. The jets pressurize, and typically also aerate the spray so that it enters the tub under force to create a bubbling and/or massaging effect.

To accommodate differing tub or basin wall thicknesses, some jets also have a head or other fitting to allow for adjustability while including the various locking mechanisms as noted above to stabilize the overall jet design. See U.S. Patent Application Publication No. US-2007-0289056-A1, which can accommodate different wall placement and includes a locking tab, locking slot and stabilizing tab on the exit nozzle, a jet head with a locking rib, and a jet cover that has a slot to receive the locking tab, a stepped portion to receive the stabilizing tab, and a lock groove to receive the locking rib. The jet cover is rotatable with respect to the exit nozzle and the nozzle engages the locking clip. A pair of locking tabs on the exit nozzle engages corresponding slots on the jet cover.

In prior designs, when the jet nozzle assembly is removed from the tub or other structure, the cover or nozzle can be damaged if the cover separates from the nozzle. Separation of the parts on installation or removal for maintenance purposes contributes to part damage. In addition, the manner in which the nozzle and the jet cover connect can cause the nozzle to wobble during operation, leading to instability of the jet, noise from vibration, and ultimately, wearing of the parts. For example, designs having a locking tab and slot configuration for attaching the cover to the nozzle can come apart upon removal from the wall fitting and/or may not attach sufficiently tightly which can also lead to vibration and noise in operation.

Thus, there is a need in the art to accomplish the desirable features of a jet nozzle, and to introduce pressurized and/or aerated water into a tub or spa after passing through a recirculation unit or system, while maintaining a smooth operation, minimizing vibration and noise, and preferably also providing a stable device, less prone to breakage and easier and less expensive to manufacture and maintain.

### BRIEF SUMMARY OF THE INVENTION

In one embodiment, the invention includes a jet nozzle assembly for use in a jet apparatus having a jet housing and a jet head, the jet nozzle assembly comprising: (a) a jet nozzle portion having a first end, a second end and a jet nozzle body extending from the first end to the second end of the jet nozzle portion, wherein the jet nozzle body is configured to provide an aerated flow of fluid for exiting the second end of the jet nozzle body and the jet nozzle body defines a passage therethough extending from the first end to the second end of the jet nozzle portion, and wherein the jet nozzle body has at least one opening for receiving fluid and/or air into the passage and has at least one fastening mechanism for attaching the nozzle body to a jet apparatus; and (b) a jet nozzle cover having an exterior surface and an interior surface, and having at least one opening extending through the jet nozzle cover from the interior surface to the exterior surface for allowing passage of fluid, wherein the jet nozzle cover and the jet nozzle portion form a unitary structure.

In further embodiments, the jet nozzle body may comprise a first portion having an interior surface comprising ribs for facilitating flow within the jet nozzle body. The jet nozzle body may also comprise a decreased width portion for restricting fluid flow through a portion of the jet nozzle body to provide aerated flow, wherein width is measured transversely across the jet nozzle body. The jet nozzle cover may have a plurality of openings therethrough and the jet nozzle body may also be formed so as to have an increased width portion for introducing fluid to the plurality of openings in the jet nozzle cover. The fastening mechanism may be a locking tab. Preferably, the jet nozzle cover and the jet nozzle portion are formed as a one-piece unitary structure. In another preferred embodiment, the jet nozzle cover and the jet nozzle portion may also be formed as two pieces which are affixed to one another to form a unitary structure. The jet nozzle cover may be affixed to the jet nozzle portion by at least one of an adhesive, a molded bead weld or by ultrasonic weld.

The invention also includes an embodiment of a jet apparatus comprising, (a) a jet housing having a jet housing body defining a passage therethrough and at least one inlet conduit configured for coupling to a water and/or air source for introducing water and/or air into the passage of the jet housing, a first end and a second end; (b) a jet head having a first end and a second end, wherein the first end is configured to connect to the second end of the jet housing and the second end of the jet head has a flange extending outwardly in a transverse direction; and (c) a jet nozzle assembly, wherein the jet nozzle assembly comprises: (i) a jet nozzle portion having a first end, a second end and a jet nozzle body extending from the first end to the second end of the jet nozzle portion, wherein the jet nozzle body is configured to provide an aerated flow of fluid for exiting the second end of the jet nozzle body and the jet nozzle body defines a passage therethough extending from the first end to the second end of the jet nozzle portion, and wherein the jet nozzle body has at least one opening for receiving fluid and/or air into the passage from the jet housing, and the jet nozzle body has at least one fastening mechanism for attaching the jet nozzle body to the first end of the jet head; and (ii) a jet nozzle cover having an exterior surface and an interior surface, and having at least one opening extending through the jet nozzle cover from the interior surface to the exterior surface for allowing passage of fluid, wherein the jet nozzle cover and the jet nozzle portion form a unitary structure, and wherein the jet head and the jet nozzle cover are configured so as to secure the jet apparatus to a mounting surface for installation.

A further embodiment includes a jet nozzle assembly for use in a jet apparatus having a jet housing and a jet head, the jet nozzle assembly comprising: (a) a jet nozzle portion having a first end, a second end and a jet nozzle body extending from the first end to the second end of the jet nozzle portion, wherein the jet nozzle body defines a passage therethough extending from the first end to the second end of the jet nozzle portion, the jet nozzle body has at least one opening for receiving fluid and/or air into the passage and has at least one fastening mechanism for attaching the nozzle body to a jet apparatus, wherein the jet nozzle body comprises a first portion having an interior surface comprising ribs for facilitating flow in the jet nozzle body, a decreased width portion for restricting fluid flow through a portion of the jet nozzle body to increase the velocity of the fluid so as to create a pressure differential, causing air to be drawn into the nozzle resulting in aerated flow of fluid for exiting the second end of the jet nozzle body, wherein width is measured transversely across the jet nozzle body, and an increased width portion; and (b) a jet nozzle cover having an exterior surface and an interior surface, and having at least one opening extending through the jet nozzle cover from the interior surface to the exterior surface for allowing passage of fluid from the increased width portion of the jet nozzle body, wherein the jet nozzle cover and the jet nozzle portion form a unitary structure.

In the embodiment noted above, the jet nozzle cover may have a plurality of openings therethrough. The fastening mechanism may be a locking tab. The jet nozzle cover and the jet nozzle portion are preferably formed as a one-piece unitary structure or the nozzle cover and the jet nozzle portion are formed as two pieces which are affixed to one another to form a unitary structure. The jet nozzle cover may be affixed to the jet nozzle portion by at least one of an adhesive, a molded bead weld or by ultrasonic weld.

The invention also includes a method of installing a jet nozzle assembly on a mounting surface of a bath tub, hot tub or spa, wherein the bath tub, hot tub or spa has a basin therein for receiving fluid, the method comprising providing a mounting wall having a mounting hole therethrough, a surface facing an interior of the basin and an opposing surface facing away from the basin; inserting a jet head, having a first end, a second end, and a flange extending outwardly from the first end, into the mounting hole so that the flange on the first end is in facing engagement with the surface of the mounting wall facing the interior of the basin and the second end is situated so as to be spaced apart from the opposing surface of the mounting wall; connecting a jet housing to the jet head; and inserting a jet nozzle assembly into the jet head, wherein the jet nozzle assembly has a jet nozzle portion including a jet nozzle body with at least one fastener thereon, and a jet nozzle cover formed together with the jet nozzle portion as a unitary structure, so that the jet nozzle body of the assembly passes through the jet head and through the mounting hole, the fastener connects to the jet head, and the cover fits over the jet head flange and against the surface of the mounting wall facing the interior of the basin.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a rear perspective view of a jet nozzle assembly according to an embodiment of the invention;

FIG. 2 is a front elevational view of a jet nozzle cover for the jet nozzle assembly of FIG. 1;

FIG. 2A is a transverse cross-sectional view of the jet nozzle cover of FIG. 2;

FIG. 2B is a longitudinal cross-sectional view of the jet nozzle portion of the jet nozzle assembly of FIG. 1;

FIG. 2C is a side elevational view of the jet nozzle portion of the jet nozzle assembly of FIG. 1;

FIG. 3 is a front perspective view of the jet nozzle assembly of FIG. 1;

FIG. 4 is a partly broken side elevational view of a jet housing for a jet apparatus according to an embodiment of the invention;

FIG. 4A is a longitudinal cross-sectional view of the jet housing of FIG. 4;

FIG. 4B is a perspective view of the jet housing of FIG. 4;

FIG. 5 is a perspective view of a jet head for a jet apparatus according to an embodiment of the invention for use with a jet housing as in FIG. 4;

FIG. 5A is a side elevational view of the jet head of FIG. 5;

FIG. 5B is a longitudinal cross-sectional view of the jet head of FIG. 5;

FIG. 6 is a partial broken view of a jet apparatus according to an embodiment of the invention having the jet nozzle assembly of FIG. 1 installed therein;

FIG. 7 is a front view of a jet cover according to an embodiment of the invention installed on a mounting surface;

FIG. 7A is a longitudinal cross-sectional view of a jet apparatus including a jet nozzle assembly according to the invention installed on a mounting surface;

FIG. 8 is side elevational view of a jet nozzle assembly according to a further embodiment of the invention;

FIG. 8A is a front elevational view of a jet nozzle cover of the embodiment shown in FIG. 8;

FIG. 9 is a front elevational view of a jet nozzle cover for an alternative embodiment of a jet nozzle assembly of the invention;

FIG. 9A is a side elevational view of the assembly shown in FIG. 9;

FIG. 9B is an exploded view of the assembly of FIG. 9;

FIG. 10 is a front elevational view of a jet nozzle cover for an alternative embodiment of a jet nozzle assembly of the invention;

FIG. 10A is a side elevational view of the jet nozzle assembly having the cover of FIG. 10;

FIG. 10B is an exploded view of the embodiment shown in FIGS. 10 and 10A;

FIG. 11 is a front end elevational view of an alternative embodiment of a jet housing for use with a jet nozzle assembly according to the invention;

FIG. 11A is a side elevational view of the embodiment of the jet housing of FIG. 11; and

FIG. 12 is a front elevational view of a jet head having an alternative configuration for use with a housing and a jet assembly according to the invention.

### DETAILED DESCRIPTION OF THE INVENTION

The present invention provides a jet nozzle assembly and jet apparatus that meet the need in the art in that the jet nozzle assembly structure provided is more stable, requires less specialty locking pieces and is easier and less expensive to manufacture. Because it has less separately interlocking pieces, there is less opportunity for part breakage on removal for maintenance or installation. The device of the invention provides a solid unit to prevent the device components from detaching, from being easily damaged in use, and which helps to prevent the nozzle from separating from the cover or becoming too loose which can lead to wobble, instability, vibration and noise in operation in prior designs. Thus, the design provides a stable, quieter and less vulnerable whirlpool jet nozzle. The components also fit together well and can be purchased largely assembled, minimizing problems that can also occur with prior devices, wherein pieces are provided that do not fit well together when interlocking the pieces.

The following is a description of preferred embodiments of the invention herein and should not be considered limiting. In the description, words such as “interior” and “exterior,” “inner” and “outer,” “rear” and “front,” “upper” and “lower,” and words of similar import are used to facilitate understanding of the invention with reference to the Figures and are not intended to be limiting to the scope of the invention.

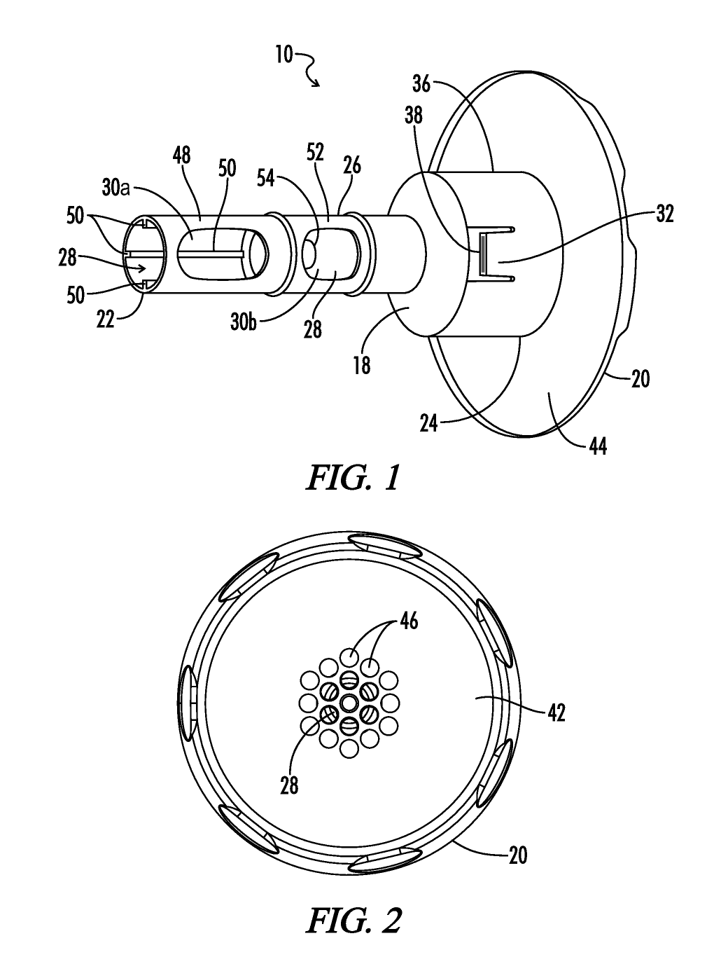

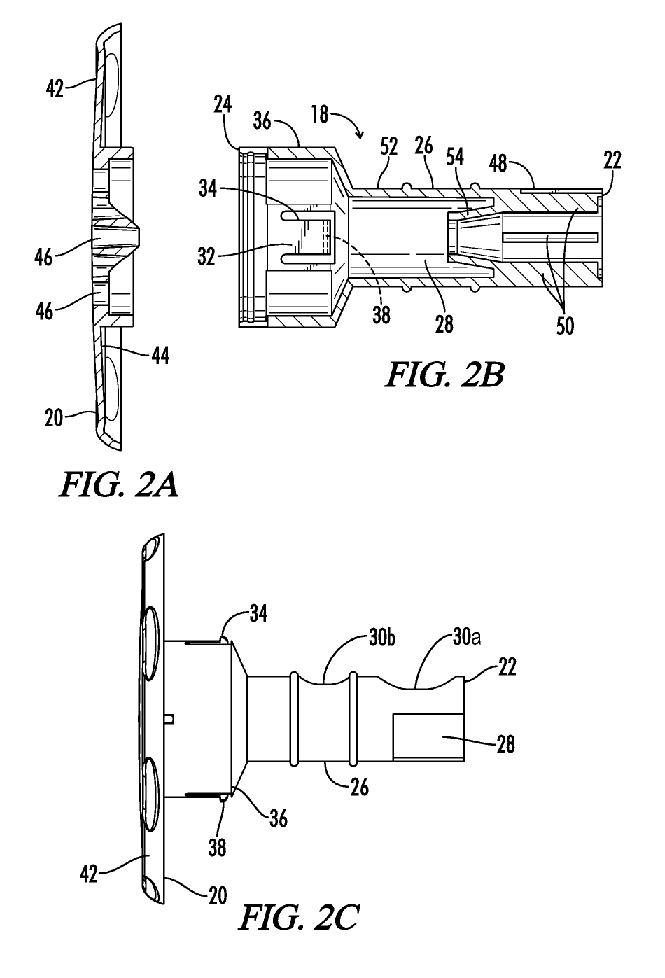

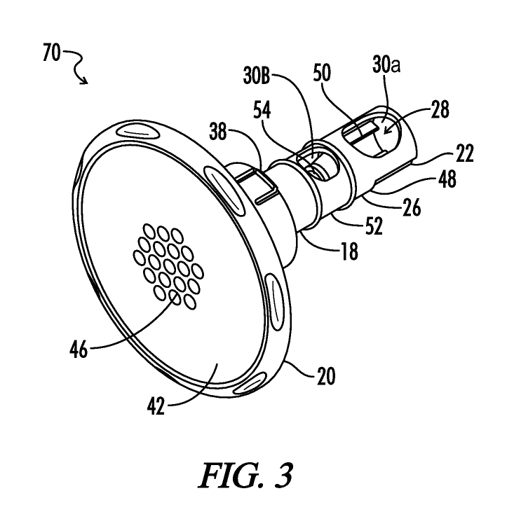

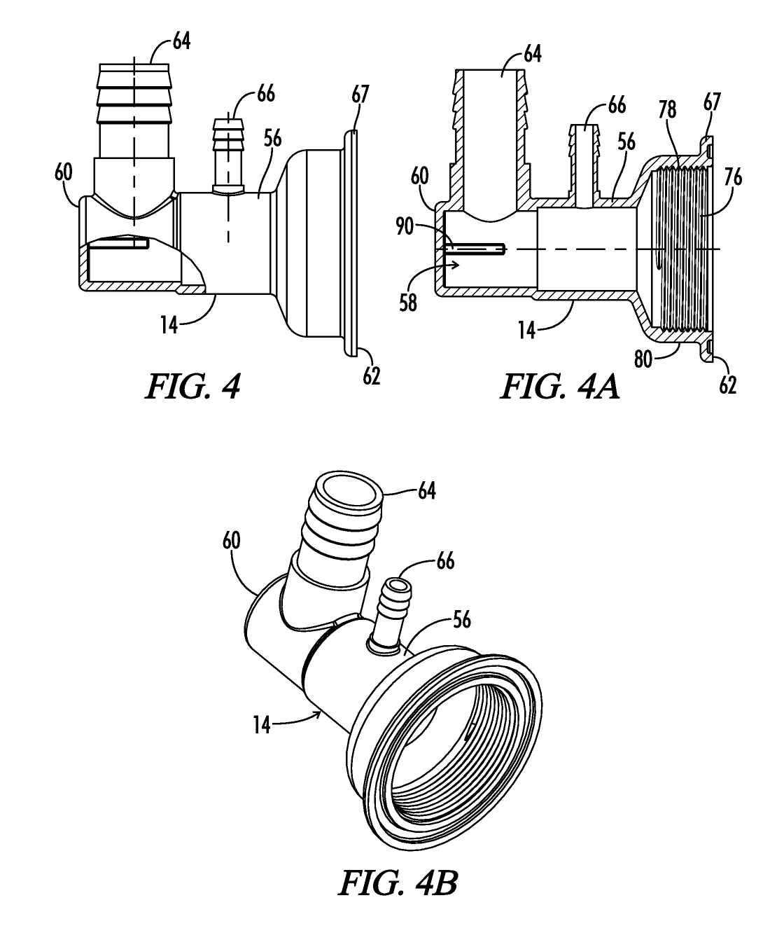

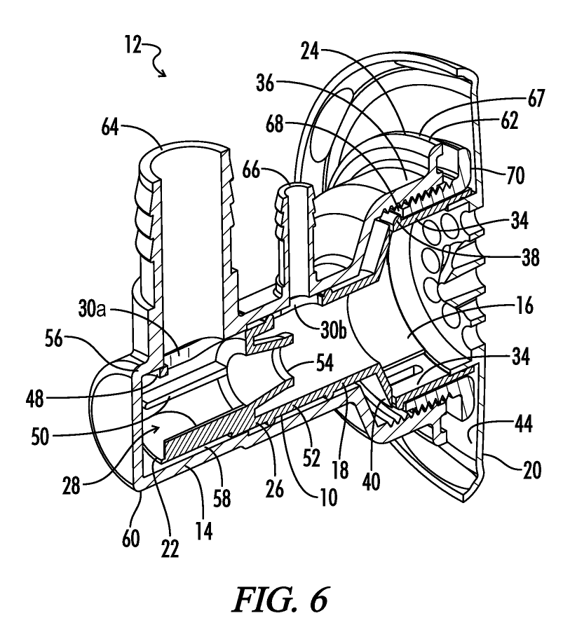

A jet nozzle assembly according to an embodiment of the invention, referred to generally herein as jet nozzle assembly 10, is shown in FIGS. 1-3. The assembly 10 is preferably used in a jet apparatus such as jet apparatus 12 herein, having a jet housing 14 and a jet head 16 (see FIGS. 4, 5, 6 and 7A). The jet nozzle assembly 10 includes a jet nozzle portion 18 and a jet cover 20. The jet nozzle portion 18 has a first end 22 and a second end 24. A jet nozzle body 26 is defined as extending between the first end 22 and the second end 24 of the jet nozzle portion 18. The jet nozzle body 26 is configured in a manner which will provide aerated flow of fluid for exiting the second end 24 of the jet nozzle portion 18. The aerated flow may be turbulent flow. In use, such jets typically deliver water for use in tubs, hot tubs, spas and the like. As used herein such structures will be referred to for convenience as a tub. Such structures typically have a mounting wall for locating the jet nozzle assembly within a jet apparatus and a basin for holding fluid such as water therein.

The fluid such as water in the flow through the jet nozzle assembly in the jet apparatus may be pressurized water, and may also be aerated such as through intake and mixture of incoming water with air to achieve varying effects. Preferably, both water and air enter the jet nozzle body 26 and combine to provide aerated water that is preferably also turbulent water and air in a mixture which is pressurized so as to exit the second end 24 of the jet nozzle portion to provide bubbling and/or massaging action in the basin of the tub to which the assembly and jet apparatus are installed.

The jet nozzle body is configured to provide such flow by incorporating an opening(s) to introduce air and/or water into the jet nozzle assembly and by preferably providing a flow restrictor of some kind as described further herein and as are known in the art or are to be developed for this purpose, for example, a smaller diameter portion, a Venturi valve, a reduced high-pressure orifice and the like. The jet nozzle body 26 defines a passage 28 therethough that extends from the first end 22 to the second end 24 of the jet nozzle portion 18. The jet nozzle body 26 has at least one opening 30a, 30b through the wall thereof for introducing fluid, such as water and/or air. Preferably there is an opening 30a for receiving fluid and an opening 30b for receiving air into the passage 28. The openings can be varied in size depending on desired effect and are preferably sized so as to enable adjustable flow on rotation of the assembly 10 in the apparatus 12 to allow more or less water and/or air to enter through openings 30a, 30b.

The jet nozzle body further has at least one fastening mechanism 32 thereon. The fastening mechanism attaches the nozzle body 26 to a jet apparatus 12, preferably to the jet head 16 of the jet apparatus. The fastening mechanism is preferably one which is difficult to detach without some application of force, but not so difficult to attach that the jet nozzle assembly 10 cannot be removed with some application of user force such as by prying or application of leverage to the outer cover 20 when installed against a mounting surface as discussed further below. Typical fastening snaps, friction lock fits, clips, interlocking pieces, locking tabs and the like may be used. In the preferred embodiment as shown, at least one, and preferably two or more locking tabs 34 are formed or affixed to (preferably formed as part of) the jet nozzle body 26 in an increased width portion 36 thereof. The locking tabs 34 can be formed so as to compress inwards toward the interior of the nozzle body 26 passage 28 when the jet nozzle assembly 10 is pushed into a jet head 16 of a jet apparatus 12. The clips push inwardly due to the inner diameter of the jet head 16 which is designed to fit snugly with the outer diameter of the increased diameter portion 36 of the jet nozzle body 26. When formed in the nozzle body, the locking tabs each preferably have an end portion 38 which extends slightly outwardly of the outer diameter of the increased diameter portion 36 of the jet nozzle body 26. Thus, when the jet nozzle body is forced into the jet head 16 the end portion 38 of the tab 34 is pushed inwards until it passes the bottom edge 40 of the jet head 16 and then will expand back outwardly so as to clip or hook along the bottom edge 40 of the jet head 16 and lock the jet nozzle body 26 and jet nozzle assembly 10 in place in the jet apparatus 12 when the jet head 16 is connected to the jet housing 14. While locking tabs 34 are described herein, it would be understood that other locking mechanisms can also be employed within the scope of the invention without departing from the spirit and scope of the invention.

The jet nozzle assembly 10 also includes a jet cover 20 which has an exterior surface 42 and an interior surface 44. The cover 20 has at least one opening 46 extending through the jet nozzle cover from the interior surface 44 to the exterior surface 42 for allowing passage of fluid exiting the jet nozzle body 26 for introducing into the basin of the tub, hot tub, spa, etc. The jet nozzle cover 20 and the jet nozzle portion form a unitary structure. Preferably a plurality of such openings 46 are provided and can be varied in size, shape and number for design reasons and for different jet effects.

The jet nozzle body 26 may have a first portion 48 having an interior surface with one or more longitudinally extending ribs 50 for assisting in fluid flow. Such ribs can act as baffles for directing flow through the jet nozzle body. Other similar features such as one or more interior facing beads, ribs or a dimpling of the surface may also be used, however, baffles or ribs are preferred.

Preferably the jet nozzle body 26 also has a decreased width portion 52 for restricting fluid flow through a portion of the jet nozzle body 26. This facilitates providing aerated flow, which flow may be turbulent flow, through the nozzle portion. This can be accomplished in a variety of ways, such as a Venturi restriction, an orifice insert and the like. As shown, a narrow flow insert 54 is located in decreased width portion 52. Thus, while the exterior diameter of the jet nozzle body 26 preferably remains generally constant through the first portion and the decreased width portion 52, the interior width of the flow area in the portion 52 decreases in diameter thus restricting flow through insert 54. The insert portion 54 may be molded in as part of the overall jet body as a single piece or otherwise affixed within the jet nozzle body. Within the decreased width portion 52, after flow exits the narrow flow insert 54 it can expand again within portion 52 before continuing through the jet nozzle body 26 and entering the increased width portion 36 and further expanding for exiting through a the jet nozzle assembly 10 by way of the openings 46 in jet cover 20. As used herein the term width means any measurement taken transversely across the jet nozzle body. In a decreased width portion the fluid flow is restricted through a portion of the jet nozzle body to increase the velocity of the fluid so as to create a pressure differential, causing air to be drawn into the nozzle resulting in aerated flow of fluid for exiting the second end of the jet nozzle body. While the exterior diameter may be constant and an insert provided, it is also possible to decrease the overall exterior width of the decreased width portion and/or provide a further insert to achieve similar effects.

As shown in FIGS. 1-3, for example, the jet nozzle body has a generally circular transverse cross-sectional shape throughout, such that the width would be the same as a diameter, however, it should be understood that while a circular cross-sectional shape is preferred, other cross-sectional shapes, such as oval, elliptical, triangular, rectangular and the like may be used. If a non-circular cross-sectional shape is used, width may be measured along the longest dimension transversely through the jet nozzle body.

It is preferred that the jet nozzle cover 20 and the jet nozzle portion 18 are a unitary structure. They may be formed by compression heat molding, plastic vacuum molding, insert molding or any other heat and/or forming process so as to be a one-piece unitary body structure. However, it is also acceptable that the jet nozzle cover 20 and the jet nozzle portion 18 are first formed as two or more pieces which are then affixed to one another to form a unitary structure. In the latter instance, the jet nozzle cover 20 may be affixed to one or more pieces making up the jet nozzle portion 18 by at least one of an adhesive, a molded bead weld, by ultrasonic weld or other affixation process. Preferably, such affixation process forms a tight and preferably motion-resistant connection that prevents the parts from twisting, being subjected to significant vibration or otherwise disconnecting in use or during removal for maintenance. It using an affixation embodiment, it is preferred that the jet nozzle portion 18 is a single unitary molded piece that is permanently affixed though heat welding, insert molding or strong adhesive to the jet nozzle cover 20.

A jet apparatus 12 herein may be any jet apparatus known in the art having the ability to incorporate and/or house a jet nozzle assembly according to the invention for installation as described herein or a similar installation method. In one embodiment, a preferred jet apparatus 12 is one having a jet housing 14 and a jet head 16. The jet nozzle assembly 10 herein can be modified to work as a replacement insert in existing jet apparatuses, wherein the internal jet nozzle assembly was previously one incorporating numerous interlocking parts. By providing the improved jet nozzle assembly, such as jet nozzle assembly 10 herein, to such jet apparatuses, the overall apparatus can be improved in stability and will resist breakage during maintenance and vibration in use.

In one embodiment herein, as shown in FIGS. 4-6 and 7A, a jet apparatus 12 includes a jet housing 14 having a jet housing body 56 defining a passage 58 therein. The jet housing body 56 includes at least one inlet conduit configured for coupling to a water and/or air source for introducing water and/or air into the passage 58 of the jet housing body. As shown in FIGS. 4 and 4A, the jet housing 14 has a first end 60 and a second end 62 with a first inlet conduit 64 for introducing water into the jet housing 14 and a second inlet conduit 66 for introducing air into the jet housing body. It should be understood based on this disclosure that additional inlets for introducing air and/or water at different angles may be provided, or only one such inlet for introducing water and/or air may also be used without departing from the spirit and scope of the invention. The inlet(s) may be made through the side wall of the housing at various locations or at the second end thereof. Preferably the inlet(s) are through the side wall of the housing.

The jet housing 14 preferably has an edge or flange 67 on the end 62 thereof for smooth and/or sealed connection (if an o-ring or gasket is provided to the flange, preferably by seating the o-ring or gasket in a sealing groove in the flange) against a mounting surface as described below when the jet apparatus is installed. The jet housing may also include one or more guide ribs/baffles 90 for fluid flow and for a tight and stable fitting between the jet housing and the jet nozzle body when installed in the jet housing. Upon rotation to change volume/flow of water and/or air through the jet nozzle assembly into the tub or spa, the ribs 90 can help the nozzle assembly rotate smoothly and stably. The jet housing 14 is preferably configured to fit reasonably snuggly around the jet nozzle body so that while allowing some fluid flow around the jet nozzle body, most fluid flow is up the passage 28 of the nozzle body from the first portion 48 of the jet nozzle body, entering through, for example, opening 30a, into the decreased width portion 52 through narrow flow insert 54 and perhaps including further air and/or water through inlet 30b, and traveling into increased diameter portion 36 and through cover 20 into the basin of the tub.

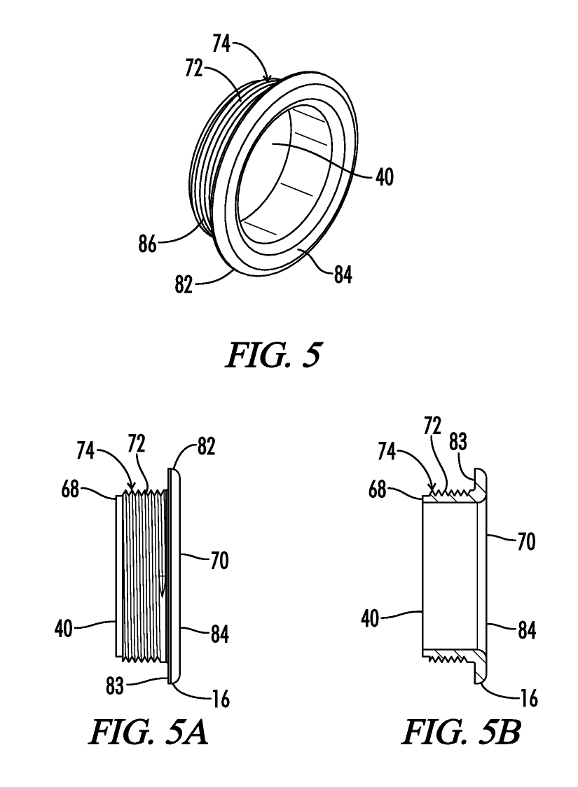

The jet apparatus 12 preferably also has a jet head 16 as shown in FIGS. 5A, 5B, 6 and 7A. The jet head 16 has a first end 68 and a second end 70. The first end 68 is configured to connect to the jet housing at or near the second end 62 of the jet housing 14. This may be done according to a variety of ways known in the art, for example, interconnecting locks, snap fit pieces, locking rings or by screw threads. As shown, the first end 68 of the jet head 16 is formed so as to have threads 72 on the outer surface 74 thereof. Mating threads 76 may then be provided as shown on an interior surface 78 of a portion 80 of the jet housing at or near the second end 62 of the jet housing. The portion 80 of the jet housing is preferably configured to be somewhat larger in width (diameter in the case of a generally circular transverse cross sectional jet housing) to be placed over the larger width portion 36 of the jet nozzle body 26 of the jet nozzle assembly 10 when the jet nozzle assembly 10 is installed in the jet apparatus 12. Mating threads are preferred as they provide a tight seal, which can be made water-tight and allow for stable locking of the housing to the jet head on installation.

The second end 70 of the jet head 16 preferably has a transversely outwardly extending flange 82 having an interior surface 83 and an exterior surface 84. The interior surface 83 operates to assist in stabilizing the jet housing and jet head as assembled when the surface 83 presses against a mounting surface 86. The flange 67 on the second end 62 of the jet housing 14 may be provided with a groove or mating groove to receive an o-ring or gasket for sealing the parts when assembled as is known in the art. The seal is tightened when the jet head 16 is tightened within the jet housing 14 and the sealing surface of flange 67 presses against the surface of a mounting wall facing away from the basin of the tub while the interior surface 83 of the flange 82 of the jet head 16 presses on the surface of the mounting wall facing the basin. The jet nozzle assembly for use in the jet apparatus is preferably the jet nozzle assembly 10 as described above.

In use and installation, a method of installation is provided herein, wherein a jet housing body installed in a tub, spa, etc. having a mounting wall. The jet housing 14 is connected using typical plumbing connection devices, such as hose fittings, interlocks, nuts, bolts, fittings, etc., to a first conduit for introducing water and/or air. An optional second conduit, such as for separately introducing air, for example, may also be connected in a similar manner. In the method, a mounting surface 86 with a mounting hole 88 therethrough is provided.

The method may use the tub having a mounting surface as described herein. A jet head, such as the jet head 16 noted above is inserted into the mounting hold so that first end of jet head having the flange of the jet head 16 extends outwardly from the mounting hole so that flange on the first end is in facing engagement with the surface of the mounting wall facing the interior of the basin and the second end of the jet head 16 is situated so as to be spaced apart from the opposing surface of the mounting wall. A jet housing is then preferably connected to the jet head. The jet housing may be connected in any suitable means depending on the design of the head and housing. However, if using the jet housing 14 and the jet head 16 described herein, the housing 14 and jet head 16, as described in one preferred embodiment can be screwed together.

The jet nozzle assembly is then inserted into the opening through the jet head from the basin side of the apparatus. The jet nozzle assembly should be the jet nozzle assembly 10 as described herein having a jet nozzle portion including a jet nozzle body with at least one fastener thereon. The assembly should also include a jet nozzle cover formed together with the jet nozzle portion as a unitary structure. Upon insertion, the jet nozzle body of the assembly 10 should pass through the jet head and through the mounting hole. The fastener then connects to the jet head, such as by snapping on as described herein using the fasteners described in the preferred embodiment of nozzle assembly 10, and the cover 20 of the assembly should fit over the jet head flange on the second end of the jet head with the cover against the surface of the mounting wall facing the interior of the basin.

The jet head 16 is preferably situated so as to pass through the mounting hole 88 in the mounting surface 86 with the exterior surface 84 of the jet head situated so that it faces the interior of the tub or spa basin having the mounting wall therein. The jet head 16 is thus situated so as to be extending backward through the mounting wall from the side of the mounting wall not facing the interior of the basin of the tub or spa.

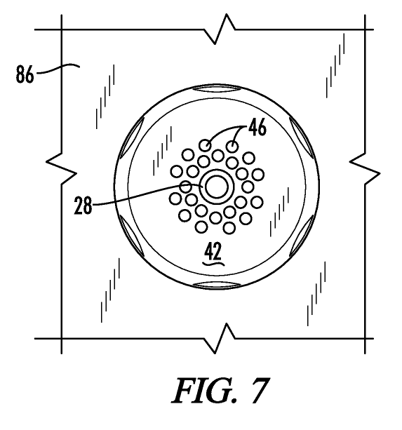

If desired, a seal, such as an o-ring or gasket, can be situated between the exterior surface of flange 67 and the mounting wall so as to provide an adequate seal. If preferred, the conduit connections to any water and/or air lines can be attached after assembly of the jet apparatus 12 to provide more flexibility in adjusting the position of the jet apparatus. With the jet nozzle assembly inserted in the mounting hole as noted above, the jet nozzle portion 18 is passed through the jet head until the bottom portion(s) 38 of the locking tab(s) 34 pass out through the bottom edge 40 of the jet head 16 and lock the jet head and the jet nozzle body together with the nozzle cover situated on one side of the mounting surface over the flange 82 of the jet head, and the second end of the jet head and the jet nozzle body are situated on the opposite surface of the mounting wall as shown in FIG. 7A. The jet housing connections may also be completed prior to assembling the jet housing to the jet head.

Once installed and tightened, the jet housing and jet head enclose the jet nozzle body on the side of the mounting surface away from the basin of the tub or spa, and the nozzle cover fits over the flange of the jet head and flush against the opposite side of the mounting surface facing the interior of the basin of the tub or spa. In use, when the water circulation system for the spa, hot tub, whirlpool or the like is turned on, air and/or water from the tub and/or from an external source is pulled or pushed through the system so that air and/or water enters the inlet conduit(s) 64, 66 of the jet housing and can pass through, if open, openings 30a, 30b in the jet nozzle body and pass through the interior of the jet nozzle body as noted above and be introduced as a jet of water and/or air through the openings 46 in the cover 20 into the basin of the tub or spa for providing whirlpool and/or massage effects.

The use of a unitary jet nozzle assembly as described herein, not only allows for easier installation, but upon installation, the jet nozzle is more stable, thus minimizing vibration. For maintenance or upon removal, the user need only leverage or otherwise pry up the cover 20 to unsnap or otherwise detach the fastening mechanism such as locking tabs 34 from the jet nozzle assembly. Once detached, the jet nozzle assembly can be pulled out through the mounting hole as one piece. After maintenance or replacement of parts, the jet nozzle assembly can be easily reinstalled or replaced. Such jet nozzle assemblies can be used as improved replacements for prior multi-component assemblies used in prior jet apparatuses as well.

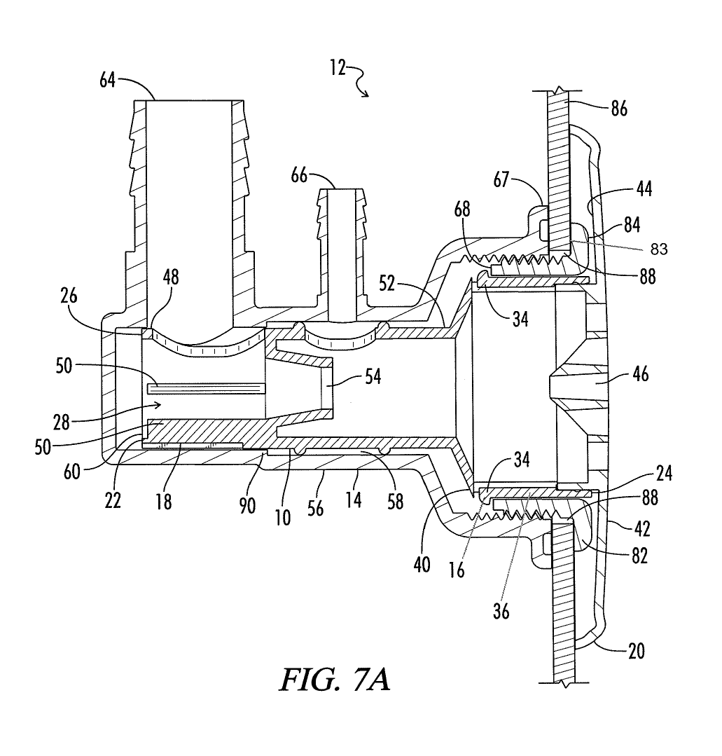

Further embodiments of a jet nozzle assembly according to the invention are shown in FIGS. 8, 8A, 9, 9A, 10 and 10A. In FIG. 8, an alternative jet nozzle assembly 110 having a jet nozzle body 126 is shown which has a narrower decreased width portion 152 than the embodiment shown in FIG. 1, however, it should be understood that assembly 110 could also have the same jet nozzle body configuration as FIG. 1 and that the embodiment of FIG. 1 could have a narrower decreased width portion as shown in the embodiment of FIGS. 8 and 8A. A further o-ring such as o-ring 153 can be used to better seal the jet nozzle body 126 when installed in a jet housing. An alternative jet nozzle cover 120 is also shown in FIG. 8A wherein fewer openings 146 are shown than the embodiment shown in FIG. 1.

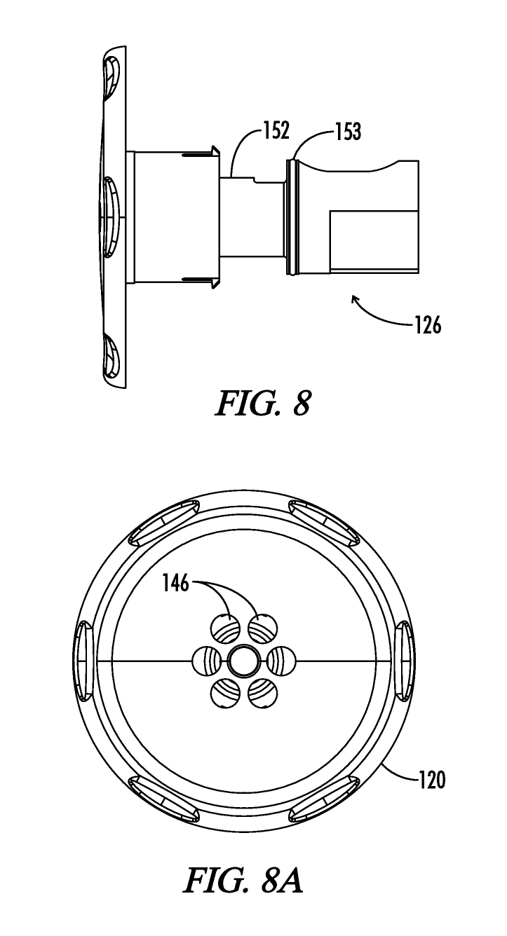

FIGS. 9, 9A and 9B show a further embodiment of an assembly 210. In FIG. 9, an alternative cover 220 having a swirl pattern 221 for gripping is provided on the surface of cover 220. Instead of one or more smaller openings, one larger opening 246 is provided. An insert eyeball-shaped piece 211 capable or rotating and directing flow is provided that can be manipulated by a user. The eyeball piece 211 sits within the interior of the jet nozzle body 226 shown in FIGS. 9A and 9B and is held by connection of the jet nozzle body 226 to the jet head within a jet apparatus used with this embodiment, and by tightening the head to the jet apparatus so that the cover is closed over the jet head outer flange and is up against the mounting surface as described above with respect to the embodiment of FIG. 1.

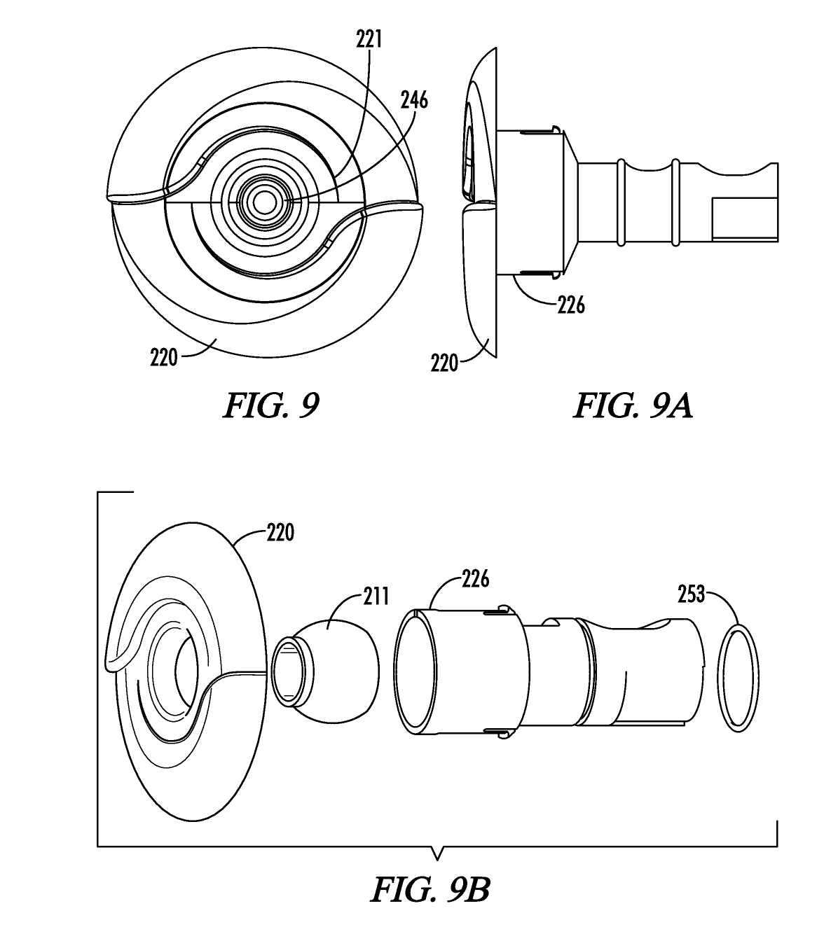

In FIGS. 10, 10A and 10B, show an embodiment of a jet nozzle assembly 310 having a rotary piece 313 for providing unique spraying action. This piece 313 is provided herein as an insert that sits in a manner situated within a jet body 326 having a cover 320 thereon with an operating extension 323 as shown. The extension 323 is behind an opening 346 through the cover 320. The jet nozzle body 326 can be similar to that of FIG. 1 or can have a narrower decreased width portion 352 as shown in FIGS. 10A and 10B.

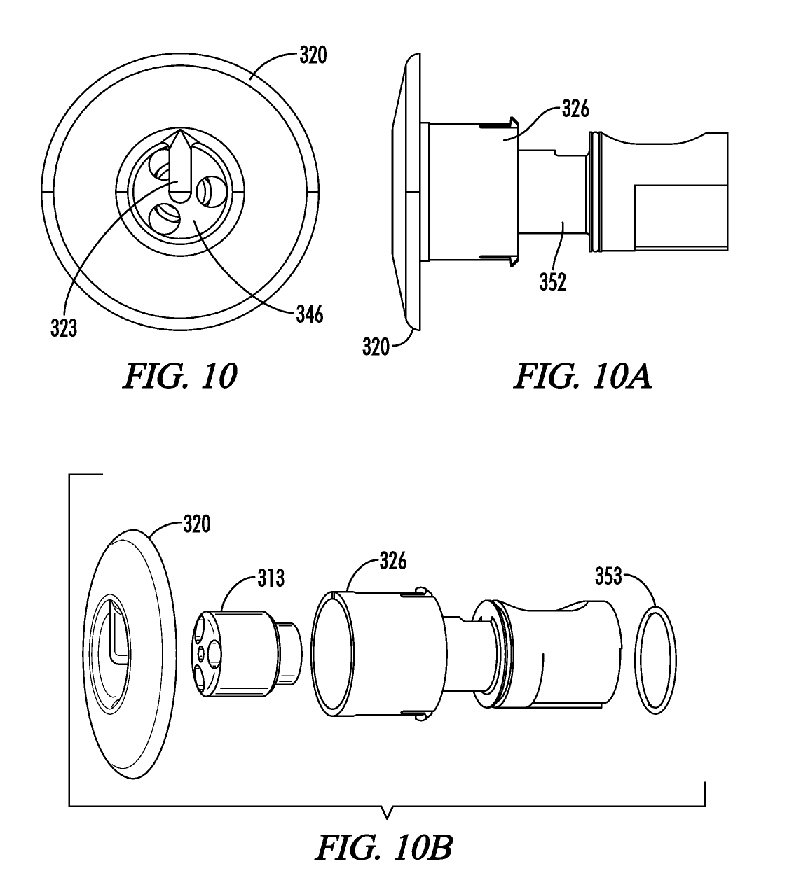

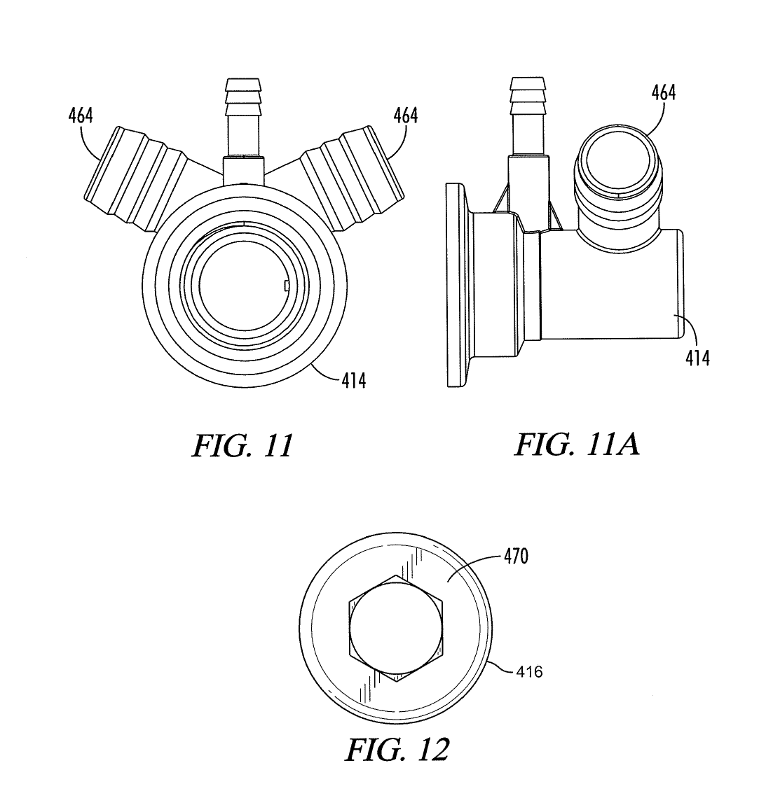

FIGS. 11, 11A and 12 show an alternative jet housing 414 and jet head 416, wherein jet housing 414 can accommodate multiple fluid inlet conduits 464, and jet head 416 can have a varied shape in its opening at the second end 470 of the jet head, wherein the opening is defined by a second end 470 having a “hex-head” configuration.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A jet nozzle assembly for use in a jet apparatus having a jet housing and a jet head, the jet nozzle assembly comprising:
(a) a jet nozzle portion having a first end, a second end and a jet nozzle body extending from the first end to the second end of the jet nozzle portion,
wherein the jet nozzle body is configured to provide an aerated flow of fluid for exiting the second end of the jet nozzle body and the jet nozzle body defines a passage therethough extending from the first end to the second end of the jet nozzle portion, and
wherein the jet nozzle body has at least one opening for receiving fluid and/or air into the passage and has at least one fastening mechanism for attaching the nozzle body to a jet apparatus; and
(b) a jet nozzle cover having an exterior surface and an interior surface, and having at least one opening extending through the jet nozzle cover from the interior surface to the exterior surface for allowing passage of fluid, wherein the jet nozzle cover and the jet nozzle portion form a unitary structure.

2. The jet nozzle assembly according to claim 1, wherein the jet nozzle body comprises a first portion having an interior surface comprising ribs for facilitating flow within the jet nozzle body.

3. The jet nozzle assembly according to claim 1, wherein the jet nozzle body comprises a decreased width portion for restricting fluid flow through a portion of the jet nozzle body to provide aerated flow, wherein width is measured transversely across the jet nozzle body.

4. The jet nozzle assembly according to claim 1, wherein the jet nozzle cover has a plurality of openings therethrough and the jet nozzle body has an increased width portion for introducing fluid to the plurality of openings in the jet nozzle cover.

5. The jet nozzle assembly according to claim 1, wherein the fastening mechanism is a locking tab.

6. The jet nozzle assembly according to claim 1, wherein the jet nozzle cover and the jet nozzle portion are formed as a one-piece unitary structure.

7. The jet nozzle assembly according to claim 1, wherein the jet nozzle cover and the jet nozzle portion are formed as two pieces which are affixed to one another to form a unitary structure.

8. The jet nozzle assembly according to claim 7, wherein the jet nozzle cover is affixed to the jet nozzle portion by at least one of an adhesive, a molded bead weld or by ultrasonic weld.

9. A jet apparatus comprising,
(a) a jet housing having a jet housing body defining a passage therein and at least one inlet conduit configured for coupling to a water and/or air source for introducing water and/or air into the passage of the jet housing, a first end and a second end;
(b) a jet head having a first end and a second end, wherein the first end is configured to connect to the second end of the jet housing and the second end of the jet head has a flange extending outwardly in a transverse direction; and
(c) a jet nozzle assembly, wherein the jet nozzle assembly comprises:
(i) a jet nozzle portion having a first end, a second end and a jet nozzle body extending from the first end to the second end of the jet nozzle portion,
wherein the jet nozzle body is configured to provide an aerated flow of fluid for exiting the second end of the jet nozzle body and the jet nozzle body defines a passage therethough extending from the first end to the second end of the jet nozzle portion, and
wherein the jet nozzle body has at least one opening for receiving fluid and/or air into the passage from the jet housing, and the jet nozzle body has at least one fastening mechanism for attaching the nozzle body to the first end of the jet head; and
(ii) a jet nozzle cover having an exterior surface and an interior surface, and having at least one opening extending through the jet nozzle cover from the interior surface to the exterior surface for allowing passage of fluid, wherein the jet nozzle cover and the jet nozzle portion form a unitary structure, and wherein the jet head and the jet nozzle cover are configured so as to secure the jet apparatus to a mounting surface for installation.

10. A jet nozzle assembly for use in a jet apparatus having a jet housing and a jet head, the jet nozzle assembly comprising:
(a) a jet nozzle portion having a first end, a second end and a jet nozzle body extending from the first end to the second end of the jet nozzle portion,
wherein the jet nozzle body defines a passage therethough extending from the first end to the second end of the jet nozzle portion,
the jet nozzle body has at least one opening for receiving fluid and/or air into the passage and has at least one fastening mechanism for attaching the nozzle body to a jet apparatus, wherein
the jet nozzle body comprises a first portion having an interior surface comprising ribs for facilitating flow in the jet nozzle body, a decreased width portion for restricting fluid flow through a portion of the jet nozzle body to increase the velocity of the fluid thereby creating a pressure differential, causing air to be drawn into the nozzle resulting in aerated flow of fluid for exiting the second end of the jet nozzle body, and wherein width is measured transversely across the jet nozzle body, and an increased width portion; and
(b) a jet nozzle cover having an exterior surface and an interior surface, and having at least one opening extending through the jet nozzle cover from the interior surface to the exterior surface for allowing passage of fluid from the increased width portion of the jet nozzle body, wherein the jet nozzle cover and the jet nozzle portion form a unitary structure.

11. The jet nozzle assembly according to claim 10, wherein the jet nozzle cover has a plurality of openings therethrough.

12. The jet nozzle assembly according to claim 10, wherein the fastening mechanism is a locking tab.

13. The jet nozzle assembly according to claim 10, wherein the jet nozzle cover and the jet nozzle portion are formed as a one-piece unitary structure.

14. The jet nozzle assembly according to claim 10, wherein the jet nozzle cover and the jet nozzle portion are formed as two pieces which are affixed to one another to form a unitary structure.

15. The jet nozzle assembly according to claim 14, wherein the jet nozzle cover is affixed to the jet nozzle portion by at least one of an adhesive, a molded bead weld or by ultrasonic weld.

16. A method of installing a jet nozzle assembly on a mounting surface of a bath tub, hot tub or spa, wherein the bath tub, hot tub or spa has a basin therein for receiving fluid, the method comprising
(a) providing a mounting wall having a mounting hole therethrough, a surface facing an interior of the basin and an opposing surface facing away from the basin;
(b) inserting a jet head, having a first end, a second end, and a flange extending outwardly from the first end, into the mounting hole so that the flange on the first end is in facing engagement with the surface of the mounting wall facing the interior of the basin and the second end is situated so as to be spaced apart from the opposing surface of the mounting wall;
(c) connecting a jet housing to the jet head; and
(d) inserting a jet nozzle assembly into the jet head, wherein the jet nozzle assembly has a jet nozzle portion including a jet nozzle body with at least one fastener thereon, and a jet nozzle cover formed together with the jet nozzle portion as a unitary structure, so that the jet nozzle body of the assembly passes through the jet head and through the mounting hole, the fastener connects to the jet head, and the cover fits over the jet head flange and against the surface of the mounting wall facing the interior of the basin.
